(19) United States
(12) Patent Application Publication
(10) Pub. No.: US 2008/0099638 A1
(43) Pub. Date: May 1, 2008

(54) Adjustable height medical device and stand therefore

(75) Inventors: Alexander M. Diener, Seattle, WA (US); Joel Aragon, Snohomish, WA (US); Bradley J. Sliger, Seattle, WA (US); Jared B. Floyd, Lynnwood, WA (US)

Correspondence Address: FULBRIGHT & JAWORSKI L.L.P, 2200 ROSS AVENUE, SUITE 2800, DALLAS, TX, 75201-2784, US

(73) Assignee: SonoSite, Inc., Bothell, WA (US)

(21) Appl. No.: 11/590,009

(22) Filed: Oct. 31, 2006

(51) Int. Cl. F16M 11/04

(52) U.S. Cl. 248/176.3

(57) ABSTRACT

The viewing angle of a display is controlled by a stand which is selectively lengthened. In one embodiment, at least one cascaded tubes are employed to allow for elongation of the stand. The stand, in one embodiment, can be rotated against the body of the device thereby creating a relatively shallow display slope angle. In a further embodiment, a plurality of cascaded tubes are disposed parallel of each other.

### CROSS-REFERENCE TO RELATED APPLICATIONS

The present application is related to concurrently filed and commonly assigned U.S. design patent application Ser. No. [Attorney Docket Number 65744-D006US-10610645], entitled “Ultrasound Display Apparatus,” and U.S. design patent application Ser. No. [Attorney Docket Number 65744-D008US-10612315], entitled “Tilt Control Support,” the disclosures of which are hereby incorporated herein by reference.

### TECHNICAL FIELD

This disclosure relates to tiling stand for use with medical apparatus and more particularly to systems and methods for changing the angle of presentation of medical data using a medical device display screen.

### BACKGROUND OF THE INVENTION

Electronic devices are now commonplace and are used in many situations. For example, in the medical field some devices, such as sonogram monitors are now portable and have display screens for monitoring of the procedure. When the operator is standing the display need to have one slope angle and when the operator is sitting the angle needs to be changed to accommodate the differing viewing heights.

In addition, adjustments need to be made depending upon the height of the surface upon which the device is positioned. These adjustments in slope angle must be made quickly and easily and must not add bulk or weight to the portable device. A further requirement is that the positioning device, while necessarily light in weight and bulk, must also be able to withstand the rigors imposed by certain embodiments, such as hospitals, battle fields and disaster scenes.

### BRIEF SUMMARY OF THE INVENTION

The viewing angle of a display is controlled by a stand which is selectively lengthened. In one embodiment, at least one cascaded tubes are employed to allow for elongation of the stand. The stand, in one embodiment, can be rotated against the body of the device thereby creating a relatively shallow display slope angle. In a further embodiment, a plurality of cascaded tubes are disposed parallel of each other.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawing, in which:

FIG. 1 shows one embodiment of a side view of a display having a slope created by a stand in accordance with one aspect of the invention;

FIG. 2 illustrates a user preparing to elongate the stand of FIG. 1;

FIG. 3 shows one embodiment of the stand in one elongated position; and

FIG. 4 shows the display having a slope created by the stand being rotated flat against a back surface of the display.

### DETAILED DESCRIPTION OF THE INVENTION

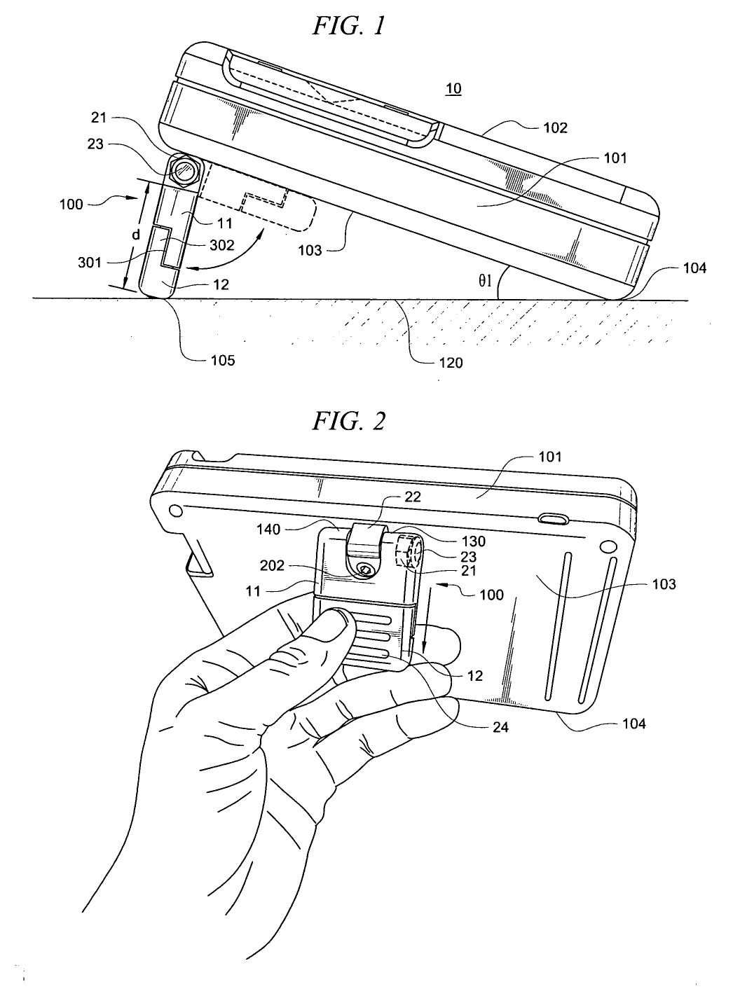

FIG. 1 shows one embodiment 10 of a side view of display 101 having a slope (e1) created by stand 100 in accordance with one aspect of the invention. Device 101 has display 102 which is sloped with respect to surface 120. The slope of the display can, as will be discussed, adjusted so that a user of device 101 can have a clear view of the display and other controls. In one embodiment, device 101 is a medical device, such as, for example, a sonogram monitor.

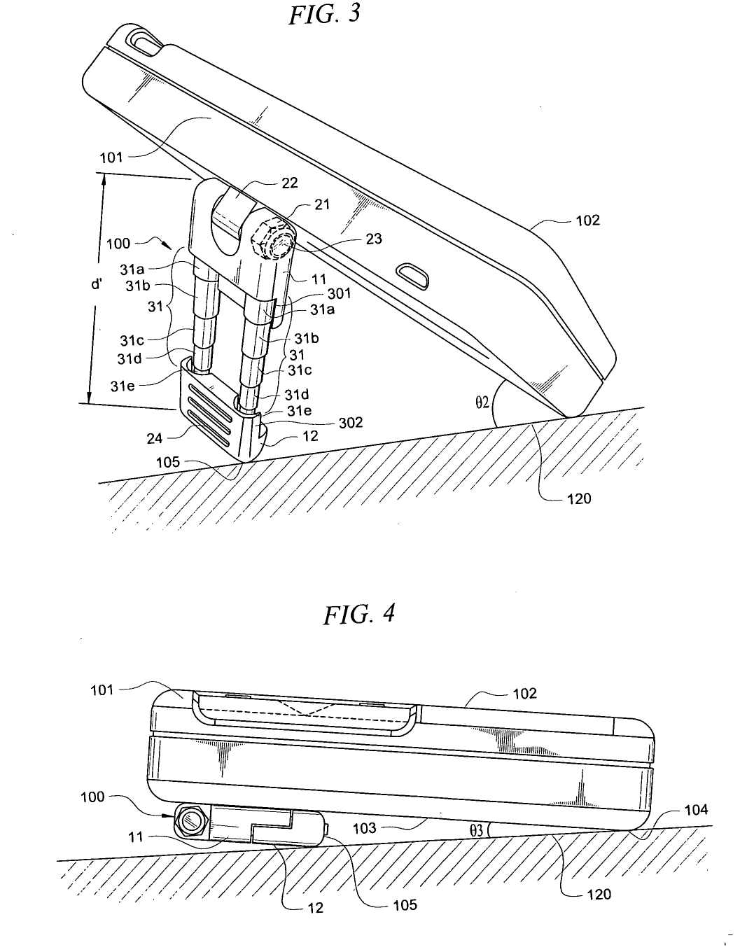

Stand 100 can be elongated along its longitudinal axis from a length of d to a length of d′ as shown in FIG. 3. Stand 100 can also be rotated so that it folds against back surface 103 of device 101. One embodiment to accomplish such rotation is shown where pin (or other fastening device) 23 is positioned through a hole in portion 130 of stand 100, through a hole in bracket 22 and into portion 140 of stand 100. Bracket 22 is secured to rear surface 103 of device 100, for example, by a fastener, such as fastener 202. Rear surface is essentially parallel to display surface 102. Bottom portion 104 of device 101 can be positioned on surface 120 to form a line of support for device 101.

Stand 100, in the embodiment shown, has two support portions 11 and 12. Support portion 11 is adapted to pivotally mate with bracket 22 (as discussed above) at its proximal end. Support portion 12 is adapted at distal end 105 to mate with a surface, such as surface 105, upon which device 101 is positioned so as to form a second contact point. In conjunction with bottom portion 104, length d of stand 100 creates a particular slope with respect to surface 120.

FIG. 2 illustrates a user preparing to elongate stand 100 by gripping support portion 12, perhaps with the assist of protrusions 24, and pulling portion 12 toward its distal end and away from support portion 11 which is affixed to the rear surface of device 101.

FIG. 3 shows one embodiment of stand 100 with support portion 12 pulled outward (away from display 101) thereby increasing the length of stand 100 to length d′. This in turn then changes the slope of display 102 to e2. In the embodiment shown, portions 11 and 12 are connected together by at least two parallel elongating portions 31. The elongating portions, as shown, have a plurality of nesting (cascading) tubes 31a, 31b, 31c, 31d, 31e that are connected at distal end 31e to support 12 and at proximal end 31a to support 11. This connection is, in one embodiment, relatively permanent and can be accomplished in any one of a number of ways, such as, for example, gluing or pinning. The cascading sections each slide inside a next larger tube and the total length can be a designer's choice. The tube sections are constructed in the well known manner so that they do not come all of the way out of the next larger tube. Note also that one or more stops can be created so that the elongation length of stand 100 (and thus the slope of display 102) can be controlled as desired.

Distal end 301 of support 11 is adapted to physically mate with proximal end 302 of support 12. Any type of mating relationship will work.

FIG. 4 shows the slope of device 102 reduced to angle ø3 by rotating stand 100 up against rear surface 103 of device 101. In this configuration, ridges 24 mate with surface 105 to form the desired slope.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A tilt adjustable medical display device comprising:
an adjustable length stand pivotally attached to said display surface, and wherein said stand comprises:
at least one longitudinally expandable portion adjustable to control a slope angle of said display with respect to a support surface.

2. The device of claim 1 wherein said longitudinally expandable portion comprises:
at least two longitudinally expandable portions in fixed parallel relationship with each other.

3. The device of claim 1 wherein at least one of said expandable portions comprises:
cascaded tubes positioned one inside the other.

4. The device of claim 3 wherein said expandable portion can be expanded to a length more than twice the length of any one of said tubes.

5. The device of claim 2 wherein said stand further comprises:
a gripping support permanently mated to the distal ends of said expandable portions, said gripping support useable by a user for adjusting the length of said expandable portions in unison.

6. The device of claim 5 wherein said display comprises:
a bottom surface for contacting a support surface for maintaining said display at a fixed elevation; and
wherein a distal end of said gripping support has a surface for mating with said support surface, and
wherein the length of said expandable portions determines a slope of said display with respect to said support surface.

7. The device of claim 6 wherein said stand comprises:
an upper support structure having a proximal end for pivotally mating with said display, said support structure mated to the proximal ends of said expandable portions; and
wherein said upper support has an end portion adapted to mate with a proximal end of said gripping support.

8. The device of claim 1 wherein said stand can be positioned to yield at least three distinct display slopes with respect to a surface upon which said display is positioned.

9. The device of claim 8 wherein said stand comprises:
at least two longitudinally expandable portions in parallel relationship with each other, said expandable portions each having a proximal end and a distal end;
a gripping support mated to said distal ends of said expandable portions; and
an upper support having a proximal end for pivotally mating with said display, said support structure permanently mated to said proximal ends of said expandable portions.

10. A stand for maintaining a display surface of a device in one of several sloped relationships with a surface upon which said device is resting; said stand comprising:
a first support for pivotally mating with a rear surface of said display surface, said rear surface substantially parallel to said display surface;
at least one longitudinally extendable structures each having proximal and distal ends; and wherein said proximal ends are mated with said first support structure; and
a second support structure separate from said first support structure, and wherein said distal ends of said extendable portions are mated with said second support structure.

11. The stand of claim 10 wherein at least one of said extendable structures comprises:
cascaded tubes positioned one inside the other.

12. The stand of claim 11 wherein said extendable portions are extended by moving said second support away from said first support; and
wherein expansion of said expandable portions determines said slope of said display with respect to said support surface.

13. The device of claim 1I wherein said stand can be adjusted to yield at least three distinct display slopes with respect to a surface upon which said display is positioned.

14. The device of claim 13 wherein said stand comprise:
a plurality of longitudinally extendable structures in parallel relationship with each other.

15. The device of claim 14 wherein said longitudinal extendable structures are disposed parallel to each other.

16. A method for adjusting the slope of a display device; said method comprising:
rotating a support structure outward from a first position in which said structure is essentially parallel to a surface of said display to a second position in which said support structure is essentially perpendicular to said display surface, said first and second positions each defining distinct pre-defined first and second slope angles of said display surface with respect to a support surface.

17. The method of claim 16 further comprising:
extending the length of said support structure thereby changing said slope angle to a slope angle dependant at least in part by said extended length.

18. The method of claim 17 wherein said extending comprises:
causing at least one collapsed cascaded lengths of tubing to emerge from one another.

19. The method of claim 18 wherein said dependant slope angle is pre-defined by a fully extended length of said support structure.

20. The method of claim 18 wherein said cascaded tubing is not visible when said support is in said first and second positions.

21. A stand for maintaining a display in one of several angled relationships with respect to a surface said stand comprising:
a first support;
means for pivotally connecting said first support to a rear surface of said display;
a second support; and
means for interconnecting said first and second supports in a longitudinally extendable relationship with each other such that an unextended length and an extended length of said stand define two of said several angled relationships, respectively, and wherein said supports maintain said interconnecting means parallel to each other.

22. The stand of claim 21 wherein said interconnecting means comprises:
at least two longitudinally extendable structures

23. The stand of claim 22 wherein said supports maintain said interconnection means parallel to each other.

24. The stand of claim 22 wherein said structures each comprise:
cascaded tubes positioned one inside the other.

25. The stand of claim 22 wherein said extendable portions are extended by moving said second support away from said first support; and
wherein expansion of said expandable portions determines said angled relationships.

26. The stand of claim 21 wherein a third angled relationship is created when said first and second supports are pivoted into the same plane as said display.
